(19) United States
(12) Patent Application Publication
(10) Pub. No.: US 2015/0136762 A1
(43) Pub. Date: May 21, 2015

(54) BOX COVER AND BOX

(71) Applicant: JENSEN ENTERPRISES, INC., Sparks, NV (US)

(72) Inventors: Donald L. Jensen, Reno, NV (US); Kurt W. Jensen, Reno, NV (US); Stephen L. Miller, Grass Valley, CA (US); Richard L. Miller, Meadow Vista, CA (US)

(21) Appl. No.: 14/546,943

(22) Filed: Nov. 18, 2014

Related U.S. Application Data
(60) Provisional application No. 61/906,842, filed on Nov. 20, 2013.

(51) Int. Cl. H02G 3/08; B28B 1/14

(52) U.S. Cl. CPC H02G 3/08; B28B 1/14
USPC 220/3.2; 264/268

(57) ABSTRACT

Embodiments of a box cover for positioning over an opening of a concrete box having an outer plastic shell with a top and a walled section extending from the top, and a concrete filler adhered to a lower surface of the top of the outer plastic shell and adhered to an interior surface of the walled section.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

1. Field of the Disclosure

The present disclosure relates generally to covers for enclosures and, in particular, to durable covers for access enclosures or boxes and methods of manufacturing same.

2. Description of the Related Art

Many varieties of box covers exist, employing a variety of techniques for improving the strength and durability of the covers. However, such covers and techniques have various limitations and disadvantages.

### SUMMARY

Disclosed herein are embodiments of a box assembly including a box cover for positioning over an opening of a box, the box cover comprising an outer plastic shell, the outer plastic shell having a top with an upper surface and a lower surface, and a walled section extending from the lower surface of the top of the outer plastic shell to thereby define a partially enclosed space bordered by the wall and the lower surface and a concrete core at least partially filling the partially enclosed space, the concrete core adhered to the lower surface of the outer plastic shell and a portion of an interior surface of the walled section.

In some embodiments, the concrete filler may not extend past a lower edge of the walled section. In some embodiments, the top of the outer plastic shell and the walled section can be monolithically formed. In some embodiments, the upper surface of the top of the outer plastic shell can have slip-resistant features.

In some embodiments, the walled section can be rectangular. In some embodiments, the walled section can be cylindrical.

In some embodiments, the box cover assembly can further comprise a plurality of braces joining the lower surface of the top of the outer plastic shell to an interior surface of the walled section to provide structural support for the walled section. In some embodiments, the box assembly can further comprise a box.

Also disclosed herein are embodiments of a method of manufacturing a box assembly including a box cover for positioning over an opening of a concrete box, the method comprising providing a cover housing formed of plastic, wherein the cover housing comprises a top having an upper surface and a bottom surface, and a wall extending from the bottom surface to thereby define a cover housing interior, positioning the cover housing such that the upper surface faces the ground and the cover housing interior can be accessed from above the cover housing, and placing wet concrete into the cover housing interior, wherein the plastic of the cover housing has sufficient rigidity to retain its shape when concrete is within the cover housing interior.

In some embodiments, the top of the cover housing and the wall can be monolithically formed. In some embodiments, the upper surface of the cover housing can comprise slip-resistant texturing. In some embodiments, the bottom surface of the top of the cover housing can comprise projections configured to bond the concrete to the cover housing when the concrete dries.

In some embodiments, the method can further comprise manufacturing a concrete box with an opening configured to receive the cover.

Also disclosed herein are embodiments of a box cover for use with a box comprising an outer plastic shell, the outer plastic shell having a top with an upper surface and a lower surface, and a walled section extending from the lower surface of the top of the outer plastic shell to thereby define a partially enclosed space bordered by the wall and the lower surface and a concrete core at least partially filling the partially enclosed space, the concrete core adhered to the lower surface of the outer plastic shell and a portion of an interior surface of the walled section.

In some embodiments, the concrete filler may not extend past a lower edge of the walled section. In some embodiments, the top of the outer plastic shell and the walled section can be monolithically formed. In some embodiments, the upper surface of the top of the outer plastic shell can have slip-resistant features.

In some embodiments, the walled section can be rectangular. In some embodiments, the walled section can be cylindrical.

In some embodiments, the box cover can further comprise a plurality of braces joining the lower surface of the top of the outer plastic shell to an interior surface of the walled section to provide structural support for the walled section.

### BRIEF DESCRIPTION OF THE DRAWINGS

FIG. 1 shows a top perspective view of an embodiment of an enclosure with a cover;

FIG. 2 shows a top perspective view of an embodiment of a casing of a box cover;

FIG. 3 shows a bottom perspective view of the embodiment of a casing of FIG. 2;

FIG. 4 shows a bottom perspective view of an embodiment of a box cover;

FIG. 5 shows a block diagram of an embodiment of a method of manufacturing a box cover.

### DETAILED DESCRIPTION

With reference to the attached figures, certain embodiments and examples of box security covers will now be described.

Disclosed herein are embodiments of a box cover that can be used to close the opening or access to the contents of a box. Such boxes may include, but are not limited to, precast concrete or polymer boxes and boxes marked or unmarked for electric, high voltage, street lighting, traffic signal, ground, signal, communication, cable TV, low voltage, CCTV, water, water meters, etc. Embodiments of boxes can be cylindrical, rectangular, or of any shape, and the shape of the box does not limit the disclosure. In some embodiments, the box can refer to a structure defining a manhole. In some embodiments, the boxes can be subsurface boxes or can be positioned above ground. Accordingly, the box can be used above ground, below ground, or in the ground, and the location of the box does not limit the disclosure.

In some embodiments, a box cover can include an outer casing, housing, or shell formed of for example, plastic, though the material does not limit the disclosure. The casing or housing can be filled with a concrete core that can help provide weight and strength to the cover. Advantageously, the concrete can provide most or all of the compression strength for the cover. The casing or housing can be configured to resist deformation, such that pouring concrete into the outer casing does not deform the casing or housing. Thus, the outer casing can receive concrete without requiring a frame or other support during manufacture, decreasing the necessary steps during manufacture.

Typically, covers for such boxes are formed out of solid concrete. However, solid concrete covers present various difficulties. For example, they can be susceptible to cracking and chipping while handling, shipping, and using. In particular, the edges are susceptible to damages when the covers are used or moved. The damage can make the box aesthetically unpleasing, as well as making the box less structurally sound. Further, chips and cracks can cut, bruise, or otherwise harm a person handling or walking over the cover.

Further, the manufacturing solid concrete covers can create difficulties. For example, concrete covers are typically formed using a rubber mold. The mold can be placed in a support box or tray that can help the mold retain its shape during the addition of the concrete. If a support box or tray was not used, the proper dimensions of the concrete cover would not be able to be made. The mold can be filled with concrete, which can be allowed to dry. The mold can be then removed from the support box or tray and peeled off of the concrete cover. However, rubber molds can wear out fairly quickly and the constant replacement of the rubber molds can increase the overall cost of manufacturing.

Various embodiments described herein are configured to provide for a box cover assembly that includes a box cover that has strength and toughness similar to concrete but lacks susceptibility to chipping and cracking, especially along the edges of the cover. Various embodiments described herein can also relate to methods of manufacture of improved covers that are easy, efficient and cost-effective. In some embodiments, manufacturing a box cover can be done without a mold and without an additional support box or tray.

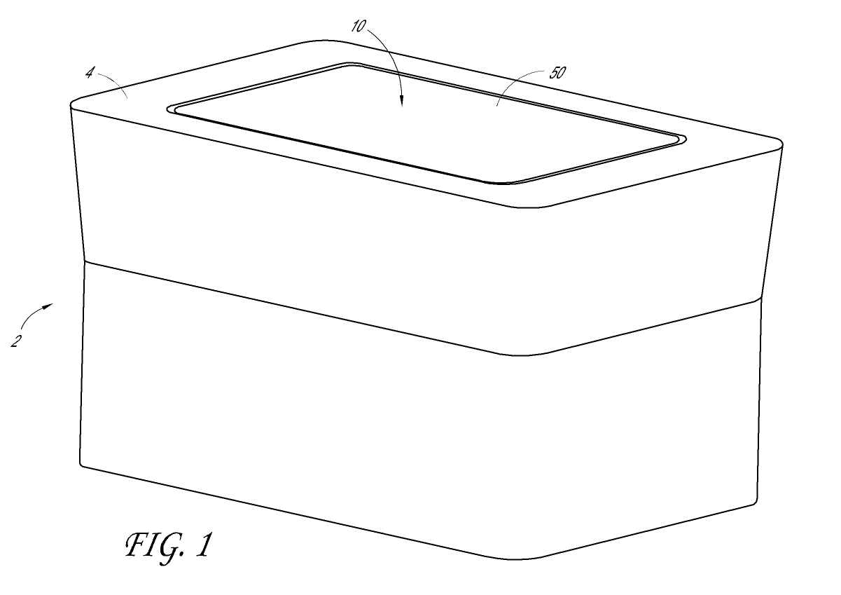

FIG. 1 illustrates an embodiment of a box 2 that can have a box cover 10 positioned to close an opening into the box. FIG. 1 shows a generally rectangular box 2, though as mentioned above the shape of the box 2 does not limit the disclosure and any desired shape (circular, triangular, etc.) can be used. The cover 10 can be at a top of the box 2 and can include a casing or housing 50 that can be flush with a top surface 4 of the box 2. In some embodiments, the casing or housing 50 can be positioned above or below the level of the top surface 4 of the box 2, and the positioning of the casing or housing 50 does not limit the disclosure. For example, the casing or housing 50 can be slightly sunken into the box 2, or partially exposed outside of the box 2. In some embodiments, the casing or housing 50 can fit tightly within the box 2. In some embodiments, there can be a slight gap between the casing or housing 50 and the box 2. Generally, unless indicated to the contrary, the directional signifiers “top” and “bottom” refer to a box 2 and cover 10 as oriented in FIG. 1.

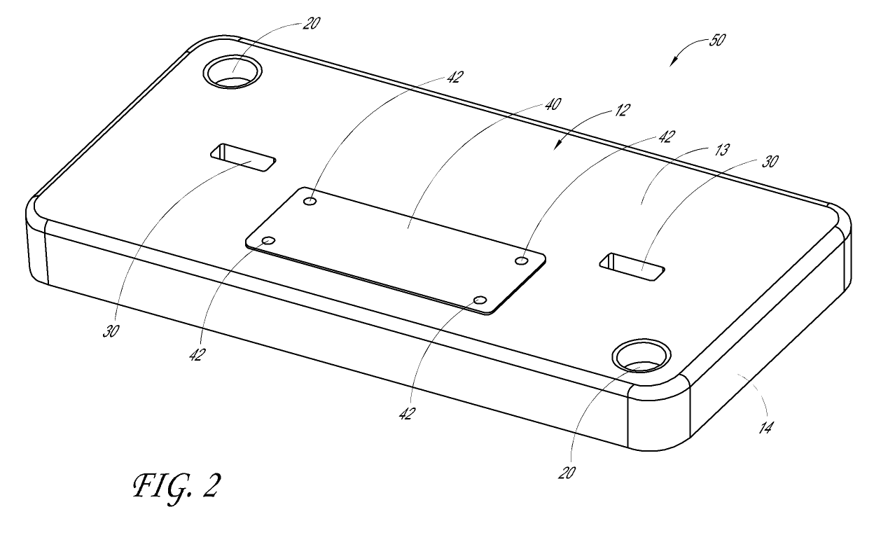

FIG. 2 illustrates a top perspective view of a casing or housing 50 that can be used to produce a box cover 10 that can be durable and easy to manufacture. The casing can include a top 12 and a plurality of side walls 14 extending down from the top 12. In some embodiments, the top 12 and side walls 14 are integrally formed. In some embodiments, the top 12 and side walls 14 are not integrally formed. In some embodiments, the top 12 and side walls 14 can have generally curved or rounded corners as shown in FIG. 2. In some embodiments, the corners can be sharp.

In some embodiments, a top surface 13 of the top 12 can be textured or have other slip-resistant features or non-slip surfaces, such as roughenings or projections, though the type of slip-resistant feature does not limit the disclosure and any slip-resistant feature can be used. In some embodiments, the material (such as plastic, though other materials could be used) used to form the casing or housing 50 of the cover 10 can be formulated to create a non-slip surface. Additionally, plastics often retain contours of non-slips patterns after wear. Thus, where a box 2 is positioned such that the casing or housing is generally level with the floor or ground, risk of slipping can be minimized or eliminated.

In some embodiments, the casing or housing 50 can form a sufficient portion of the upper surface of a cover 10 to provide a meaningful non-slip surface. In some embodiments, at least 20%, 30%, 40%, 50%, 60%, 70%, 80%, or all of the upper surface of the cover 10 can be formed of plastic. In some embodiments, the upper surface of the cover 10 can define a non-slip pattern on at least 20%, 30%, 40%, 50%, 60%, 70%, 80%, or all of the upper surface of the cover.

The casing or housing 50 can be formed of a plastic material. Desirably, an appropriate plastic known to those skilled in the art can be used, such as a plastic that is moldable, provides rigidity when molded so that the casing can retain its shape, and provides a non-slip surface or can be formulated or molded to create a non-slip surface. The plastic preferably resists damage from impacts as well. In some embodiments, other types of materials may be used, and the type of material does not limit the disclosure.

In some embodiments, the casing or housing 50 can have different shapes. In the illustrated embodiment, the side walls 14 and top 12 form a rectangle. In some embodiments, the housing can be round (with cylindrical side walls), hexagonal, or of other desired shapes. The shape of the casing or housing 50 does not limit the disclosure.

In some embodiments, the outer casing or housing 50 may not flex more than the expected tolerances for the assembly between the box 2 and the cover 10 when the casing or housing 50 is filled with concrete. In some embodiments, the casing or housing 50 may flex no more than about 1/16 of an inch, ⅛ of an inch, 3/16 of an inch, or ¼ of an inch when the casing or housing 50 is filled with concrete. In some embodiments, the casing or housing 50 may flex no more than about 1/16 of an inch, ⅛ of an inch, 3/16 of an inch, or ¼ of an inch when the casing or housing 50 is filled with concrete having a density between 1700 and 2500 kg/m³. In some embodiments, the casing or housing 50 may flex no more than about 1/16 of an inch, ⅛ of an inch, 3/16 of an inch, or ¼ of an inch when the casing or housing 50 is filled with concrete having a density of approximately 2000 kg/m³.

In various embodiments, the casing or housing 50 can include one or more features that can be used to help manipulate or maneuver a cover once the casing or housing 50 has been filled with concrete. Thus, for example, in some embodiments a casing or housing 50 can include one or more first access points 20, which can be used to help move the cover, such as to lift the cover off of its position on a box. The first access points 20 can be generally circular, as shown in FIG. 2, or can be other shapes, and the shape of the access points 20 is not limiting. In some embodiments, the first access points 20 can extend into the thickness of the casing or housing 50 without creating a through hole. For example, the bottom of the first access point 20 can be closed. In some embodiments, the first access points 20 can create a through hole. In some embodiments, the first access points 20 can extend ¼, ½, or ¾ through the depth of the side walls 14. In some embodiments, the first access points 20 can extend greater than ¼, ½, or ¾ through the depth of the side walls 14. In some embodiments, the first access points 20 can extend less than ¼, ½, or ¾ through the depth of the side walls 14.

In some embodiments, the casing or housing 50 can include one or more second access points 30, which can be configured to receive different types of tools to help maneuver and manipulate the cover. For example, the second access points 30 can be configured to accept and retain, for example, a wrench, screwdriver, or crowbar. As shown in FIG. 2, the second access points 30 can be generally rectangular, though the shape of the second access points 30 does not limit the disclosure. The second access points 30 can extend into the thickness of the casing or housing 50 without creating a through hole. In some embodiments, the second access points 30 can extend ¼, ½, or ¾ through the depth of the side walls 14. In some embodiments, the second access points 30 can extend greater than ¼, ½, or ¾ through the depth of the side walls 14. In some embodiments, the second access points 30 can extend less than ¼, ½, or ¾ through the depth of the side walls 14.

In some embodiments, as illustrated in FIG. 2, the casing or housing 50 can include a nameplate 40 that can be used to identify the particular contents of the box. The nameplate 40 can be generally rectangular, as shown in FIG. 2, though other shapes can be used and the shape does not limit the disclosure. The nameplate 40 can be attached to the casing or housing 50 with, for example, plates, screws or attachment mechanisms 42, and the type of attachment mechanism 42 is not limiting.

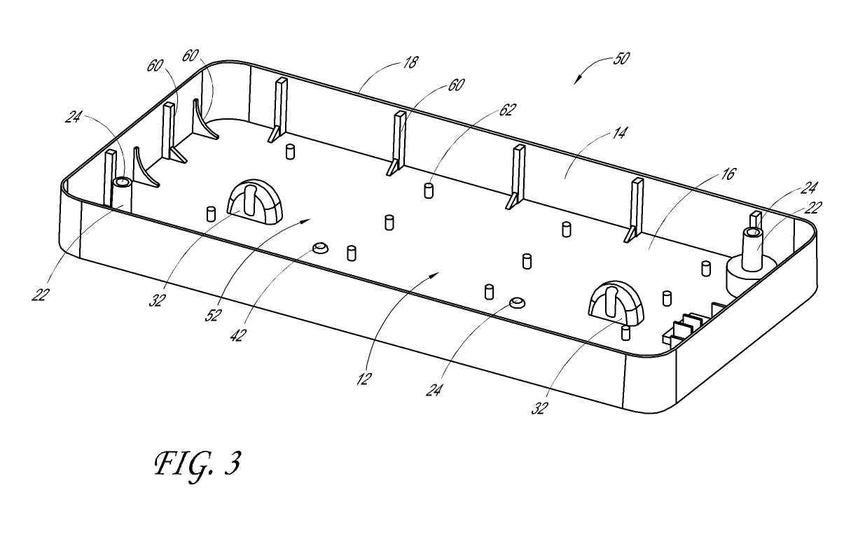

FIG. 3 illustrates a bottom perspective view of the casing or housing 50. As illustrated in FIG. 3, the side walls 14 can extend from a bottom surface 16 of the top 12 of the casing. Accordingly, the casing or housing 50 can be generally “hollow”. In some embodiments, the casing or housing 50 can include one or more types of side wall supports 60. The supports 60 can be configured to help provide structural support for the walls 14, such that the walls 14 can maintain their position when the housing is filled with concrete. This can prevent the need for a support box or tray to help maintain the shape of the casing or housing 50 when it is filled with concrete. However, in some embodiments no supports 60 are used. In some embodiments, 4 supports 60 can be used on the short wall 14, and 5 supports 60 can be used on the long wall 14. However, the number of supports 60 used is not limiting and any number can be used. In some embodiments, the short and long walls 14 can have a different number of supports 60. In some embodiments, the short and long walls 14 can have the same number of supports 60. In some embodiments, 1, 2, 3, 4, 5, 6, 7, 8, 9, or 10 supports 60 can be used per wall 14. In some embodiments, greater than 1, 2, 3, 4, 5, 6, 7, 8, 9, or 10 supports 60 can be used per wall 14. In some embodiments, less than 2, 3, 4, 5, 6, 7, 8, 9, or 10 supports 60 can be used per wall 14.

In some embodiments, the housing 50 can include one or more attachment projections 62 extending downward from the bottom surface 16 of the top 12 of the housing. The projections can be configured to help ensure a connection between concrete poured into the casing or housing 50 and the casing or housing 50 itself. In some embodiments, attachment projections can extend from the side walls 14 in addition to or instead of extending from the bottom surface 16. In some embodiments, the projections 62 can be generally cylindrical, though the shape of the projections 62 is not limiting. In some embodiments, the projections 62 may be indicated on the top 12. In some embodiments, the projections 62 may not be indicated on the top 12. In some embodiments, the projections 62 may be randomly spaced. In some embodiments, the projections 62 can be in rows, where the projections 62 can be aligned from the axis extending from short wall 14 to the opposite short wall 14, the long wall 14 to the opposite long wall 14, or both. In some embodiments, 1, 2, 3, 4, 5, or 6 rows of projections 62 can be used extending from one long wall 14 to the opposite. In some embodiments, greater than 1, 2, 3, 4, 5, or 6 rows of projections 62 can be used extending from one long wall 14 to the opposite. In some embodiments, less than 2, 3, 4, 5, or 6 rows of projections 62 can be used extending from one long wall 14 to the opposite. In some embodiments, 1, 2, 3, 4, 5, or 6 rows of projections 62 can be used extending from one short wall 14 to the opposite. In some embodiments, greater than 1, 2, 3, 4, 5, or 6 rows of projections 62 can be used extending from one short wall 14 to the opposite. In some embodiments, less than 2, 3, 4, 5, or 6 rows of projections 62 can be used extending from one short wall 14 to the opposite.

Also visible on FIG. 3 are first access projections 22, which can define first access points 20 on the top surface 13 of the top 12 (visible in FIG. 2). In some embodiments, the first access projections 22 can extend below a bottom rim 18 of the side walls 14. Thus, if concrete is poured to the level of the bottom rim 18, a first access exit 24 will be positioned below the level of the concrete such that a tool can be inserted all the way through the access projection 22 to help manipulate or remove the cover 10. Inserting a tool through the access projection 22 and not directly through the concrete of a cover can help prevent chipping or damage to the concrete caused by the tool, thus increasing the overall life of the box cover 10.

In some embodiments, second access projections 32 that define the second access points 30 can extend from the bottom surface 16 of the top 12. In some embodiments, the second access projections 32 do not extend to the level of the rim 18. In some embodiments, the second access projections 32 can extend to or beyond the level of the rim 18.

Manufacturing various embodiments of covers as described herein can include pouring concrete into the interior 52 of the casing or housing 50. In some embodiments, the walls 14 can be sufficiently stable such that no outside supports or special positioning is required for the casing or housing 50 to maintain its shape. Thus, concrete can be poured into the casing or housing 50 when its bottom surface 16 faces upward, regardless of where the casing or housing 50 is positioned.

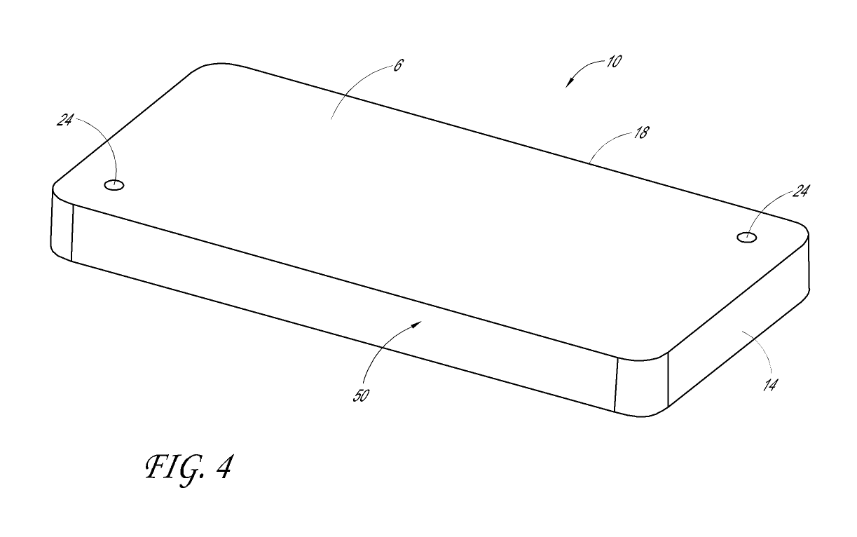

FIG. 4 illustrates an embodiment of a cover 10 that includes a housing 50 that has been filled with concrete 6. FIG. 4 shows the same viewpoint as that of FIG. 3. The concrete 6 can at least partially, or fully, fill the housing interior 52. In some embodiments, the concrete can be generally level with the bottom rim 18 of the walls 16, although in some embodiments the concrete can be slightly above or below the rim. As illustrated in FIG. 4, the first access exits 24 can be accessible through the concrete, such that a tool can be inserted through the access projections to move or manipulate the cover 10.

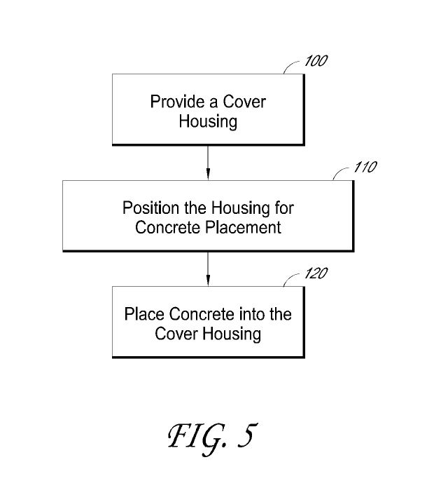

FIG. 5 is a block diagram illustrating one embodiment of a method of manufacturing a box cover. The method can include the steps of providing a cover housing, illustrated in block 100. As described above, the cover housing can include a top with an upper and lower surface, and a wall extending from the lower surface to define an interior of the cover housing. The housing can be positioned for placement of concrete at block 110. This can involve positioning the housing with the upper surface of the top facing down, such that the interior can be accessed from above. At block 120, concrete can be placed into the interior of the housing. Placement of concrete can involve pouring, injecting, positioning, inserting, or any other method by which concrete moves into the interior of the housing. The method of placement of the concrete does not limit the disclosure.

From the foregoing description, it will be appreciated that an inventive box covers and boxes are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,”“about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount.

Some embodiments have been described in connection with the accompanying drawings. The figures are drawn to scale, but such scale should not be limiting, since dimensions and proportions other than what are shown are contemplated and are within the scope of the disclosed inventions. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A box assembly including a box cover for positioning over an opening of a box, the box cover comprising:
an outer plastic shell, the outer plastic shell having a top with an upper surface and a lower surface, and a walled section extending from the lower surface of the top of the outer plastic shell to thereby define a partially enclosed space bordered by the wall and the lower surface; and
a concrete core at least partially filling the partially enclosed space, the concrete core adhered to the lower surface of the outer plastic shell and a portion of an interior surface of the walled section.

2. The box assembly of claim 1, wherein the concrete filler does not extend past a lower edge of the walled section.

3. The box assembly of claim 1, wherein the top of the outer plastic shell and the walled section are monolithically formed.

4. The box assembly of claim 1, wherein the walled section is rectangular.

5. The box assembly of claim 1, wherein the walled section is cylindrical.

6. The box cover of claim 1, further comprising a plurality of braces joining the lower surface of the top of the outer plastic shell to an interior surface of the walled section to provide structural support for the walled section.

7. The box assembly of claim 1, wherein the upper surface of the top of the outer plastic shell has slip-resistant features.

8. The box assembly of claim 1, further comprising a box.

9. A method of manufacturing a box assembly including a box cover for positioning over an opening of a concrete box, the method comprising:
providing a cover housing formed of plastic, wherein the cover housing comprises a top having an upper surface and a bottom surface, and a wall extending from the bottom surface to thereby define a cover housing interior;
positioning the cover housing such that the upper surface faces the ground and the cover housing interior can be accessed from above the cover housing;
placing wet concrete into the cover housing interior, wherein the plastic of the cover housing has sufficient rigidity to retain its shape when concrete is within the cover housing interior.

10. The method of claim 9, wherein the top of the cover housing and the wall are monolithically formed.

11. The method of claim 9, wherein the upper surface of the cover housing comprises slip-resistant texturing.

12. The method of claim 9, wherein the bottom surface of the top of the cover housing comprises projections configured to bond the concrete to the cover housing when the concrete dries.

13. The method of claim 9, further comprising manufacturing a concrete box with an opening configured to receive the cover.

14. A box cover for use with a box comprising:
an outer plastic shell, the outer plastic shell having a top with an upper surface and a lower surface, and a walled section extending from the lower surface of the top of the outer plastic shell to thereby define a partially enclosed space bordered by the wall and the lower surface; and
a concrete core at least partially filling the partially enclosed space, the concrete core adhered to the lower surface of the outer plastic shell and a portion of an interior surface of the walled section.

15. The box cover of claim 14, wherein the concrete filler does not extend past a lower edge of the walled section.

16. The box cover of claim 14, wherein the top of the outer plastic shell and the walled section are monolithically formed.

17. The box cover of claim 14, wherein the walled section is rectangular.

18. The box cover of claim 14, wherein the walled section is cylindrical.

19. The box cover of claim 14, further comprising a plurality of braces joining the lower surface of the top of the outer plastic shell to an interior surface of the walled section to provide structural support for the walled section.

20. The box cover of claim 14, wherein the upper surface of the top of the outer plastic shell has slip-resistant features.
